(19) United States
(12) Patent Application Publication
(10) Pub. No.: US 2008/0073597 A1
(43) Pub. Date: Mar. 27, 2008

(54) Ultraviolet lamp

(76) Inventor: Tommy Chi-Kin Wong, Kowloon Bay (HK)

Correspondence Address: RABIN & Berdo, PC, 1101 14TH STREET, NW, SUITE 500, WASHINGTON, DC, 20005, US

(21) Appl. No.: 11/583,704

(22) Filed: Oct. 20, 2006

(30) Foreign Application Priority Data
Apr. 21, 2006 (CN) 200610060455.8

(51) Int. Cl. G01J 3/10

(52) U.S. Cl. 250/504 R

(57) ABSTRACT

An ultraviolet lamp is comprised of a lamp that transmits the ultraviolet and an electrode that is embedded in the lamp lumen and produces the ultraviolet, or a non-electrode lamp where the substance embedded in the lamp sleeve produces the ultraviolet by microwave; in addition, an indicator is installed on the lamp to transfer the ultraviolet into visible light. This indicator is able to transfer the ultraviolet into colored visible light when the ultraviolet lamp works and the existence and strength of the ultraviolet are directly observed through observation on the color shades or the emitted character or sign.

### BACKGROUND OF THE INVENTION

I. Field of the Invention

The invention relates to a type of ultraviolet lamp, more particularly, an ultraviolet lamp emits the ultraviolet by electrode or microwave.

II. Description of the Prior Art

Nowadays, a common ultraviolet lamp is usually comprised of a lamp which transmits the ultraviolet, mercury, and electrodes. The ultraviolet is invisible to the human eye which neither the factory operator nor the user is able to perceive or even realize its strength in the process of production or in its usage. Furthermore, it easily causes negative effects on human health through long-term exposure to the ultraviolet or short-time exposure to the maximized ultraviolet. Therefore, measuring the existence and strength of the ultraviolet becomes indispensable. Nevertheless, with reference to existing technology, the ultraviolet can only be measured by expensive instruments whose complicated operation causes inconvenience to the use as well as detection and quality inspection in the process of production. The supply of ultraviolet lamps waiving off the foregoing drawbacks is consequently an unsolvable technical topic at present.

### SUMMARY OF THE INVENTION

Objective of the invention is to provide an ultraviolet lamp where the existence and strength of the ultraviolet can be observed directly, or through a transparent shell, or through a partial transparent shell, which is opaque to the ultraviolet.

Objective of the invention is embodied as follows: providing an ultraviolet lamp comprised of a lamp which is able to transmit the ultraviolet, a substance such as mercury or its substitute which is embedded in the lamp and produces the ultraviolet by electrodes or microwave as well as an indicator which is embedded in any part of the lamp and is able to transfer the ultraviolet into colored visible light.

A further improvement made in the ultraviolet lamp by the invention is: the said lamp is of sleeve type and the said indicator is installed on the wall of one or several ends adjoining the sleeve-type lamp.

A further improvement made in the ultraviolet lamp by the invention is: the ultraviolet lamp is comprised of one or several of the said lamps and several lamps are horizontally in parallel connection. The said indicator is installed on the wall of one or several ends adjoining the said lamp.

A further improvement made in the ultraviolet lamp by the invention is: the said lamp is of sleeve type and is bent into one or several arc-shaped tubes; the said indicator is installed on the wall of one or several ends adjoining the said lamp.

A further improvement made in the ultraviolet lamp by the invention is: the said lamp is of sleeve type and has no electrodes; the said indicator is installed on any end adjoining the sleeve-typed lamp.

A further improvement made in the ultraviolet lamp by the invention is: the said ultraviolet lamp may be a non-electrode ultraviolet lamp.

A further improvement made in the ultraviolet lamp by the invention is: the said non-electrode ultraviolet lamp means one or several ultraviolet-emission lamps to be sealed with a certain quantity of mercury after vacuum.

The further improvement made in the ultraviolet lamp by the invention is: the ultraviolet emitted by the said non-electrode ultraviolet lamp is produced while the microwave ionizes the mercury or its substitute.

A further improvement made in the ultraviolet lamp by the invention is: the said indicator is comprised of the substance that is able to transfer the ultraviolet energy into visible light.

A further improvement made in the ultraviolet lamp by the invention is: the said indicator is comprised of the substance that is able to transfer the ultraviolet energy into colored visible light.

A further improvement made in the ultraviolet lamp by the invention is: a substance, which is able to strengthen the light or adjust the spectrum, is installed between the said indicator and the said lamp.

A further improvement made in the ultraviolet lamp by the invention is: the said substance that transfers the ultraviolet into colored visible light is phosphorus or fluorescent powder.

A further improvement made in the ultraviolet lamp by the invention is: a color match is installed on the surface of the said lamp and beside the said indicator.

A further improvement made in the ultraviolet lamp by the invention is: the transparent or opaque character or sign is installed on the surface of the said lamp and right above the said indicator.

Compared to existing technology, the ultraviolet lamp of the invention has an indicator installed on the lamp to transfer the ultraviolet into colored visible light. When the ultraviolet lamp of the invention works, the said indicator transfers the ultraviolet into visible light; of which the color shades and strength are observable so as to reveal the existence and strength of the ultraviolet.

### BRIEF DESCRIPTION OF THE DRAWINGS

FIG. 1 is a structural view of the first embodiment of the present invention.

FIG. 2 is a structural view of the second embodiment of the present invention.

FIG. 3 is a structural view of the third embodiment of the present invention.

FIG. 4 is a structural view of the fourth embodiment of the present invention.

FIG. 5 is a structural view of the fifth embodiment of the present invention.

FIGS. 6-1, 6-2 and 6-3 are respective structural views of the sixth embodiment of the present invention.

### DESCRIPTION OF THE PREFERRED EMBODIMENT

Further structure, installation, and desirable features of the invention will be better understood from the detailed description and drawings that follows in which various embodiments of the disclosed invention are illustrated by way of example.

The ultraviolet lamp of the invention is comprised of a lamp that is able to emit the ultraviolet and a substance such as mercury or its substitute that is embedded inside the lamp and produces the ultraviolet by the electrode or microwave. In addition, an indicator is installed on any part of the said lamp and is able to transfer the ultraviolet into colored visible light. Consequently, the existence and strength of the ultraviolet become observable in the work without the help of any instruments.

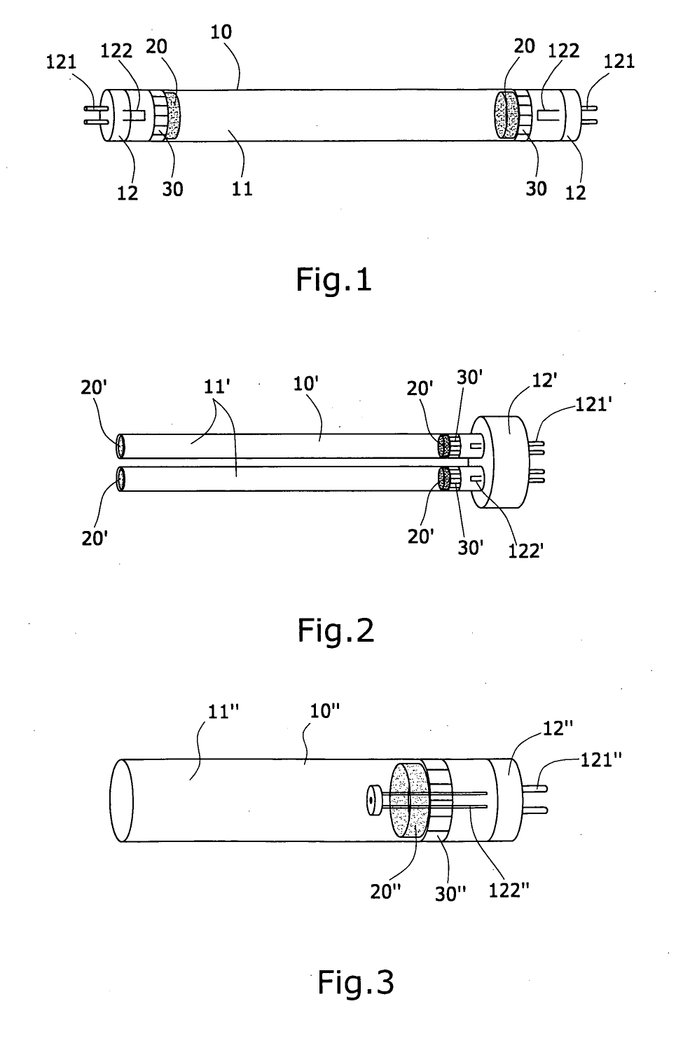

Specifically, FIG. 1 is a structural view of the first embodiment of the invention—an ultraviolet lamp 10, which is comprised of a sleeve-typed lamp 11 and lamp-holders 12 on both ends of the lamp 11. The connection of the lamp-holder 12 and the lamp 11 is hermetic. The electrode 122 is embedded inside the lamp 11 and is extended to the outside of the lamp 11 to connect with the electric conduction pin 121. In addition, the indicators 20 are installed on the walls at both ends of the lamp 11. In addition, such installation rarely affects the utilization of the ultraviolet.

FIG. 2 is a structural view of the second embodiment of the invention—an ultraviolet lamp 10′, which is comprised of two sleeve-shape lamps 11′ and one shared lamp-holder 12′ on one end of the lamp 11′. The connection of the lamp-holder 12′ and the lamp 11′ is hermetic. The electrode 122′ is embedded in the lumen of the lamp 11′ and is extended to the outside of the lamp 11′ to connect with the electric conduction pin 121′. Furthermore, each lamp 11′ has an electrode 122′ on the end attached to the lamp-holder and the indicators 20′ are installed on both ends of the lamp 11, which rarely affects the utilization of the ultraviolet.

FIG. 3 is a structural view of the third embodiment of the invention—an ultraviolet lamp 10″, which is comprised of one sleeve-type lamp 11″ and one lamp-holder 12″ on one end of the lamp 11″. The connection of the lamp-holder 12″ and the lamp 11″ is hermetic. The electrode 122″ is embedded in the lumen of the lamp 11″ and is extended to the outside of the lamp 11″ to connect with the electric conduction pin 121″. Furthermore, the lamp 11″ has an indicator 20″ on the wall where the electrode 122″ is installed; this rarely affects the utilization of the ultraviolet.

From the forgoing embodiments, the indicator 20, 20′, 20″ is a substance such as fluorescent powder that is able to change ultraviolet energy into visible light of various colors in different shades. When the ultraviolet lamp 10, 10′, 10″ works, the ultraviolet produced by the electrode 122, 122′, 122″ radiates on the fluorescent powder so as to make the existence and strength of the ultraviolet directly observable.

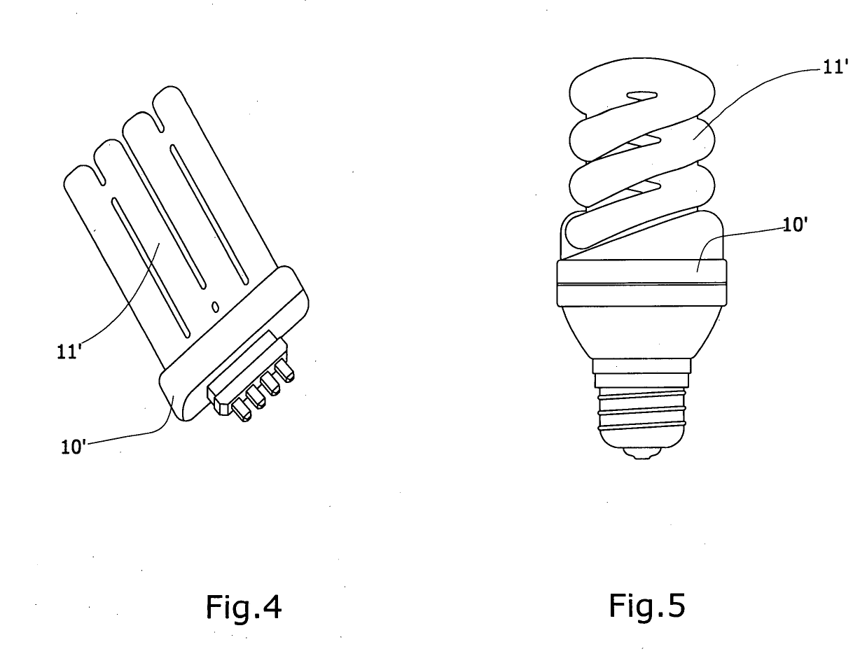

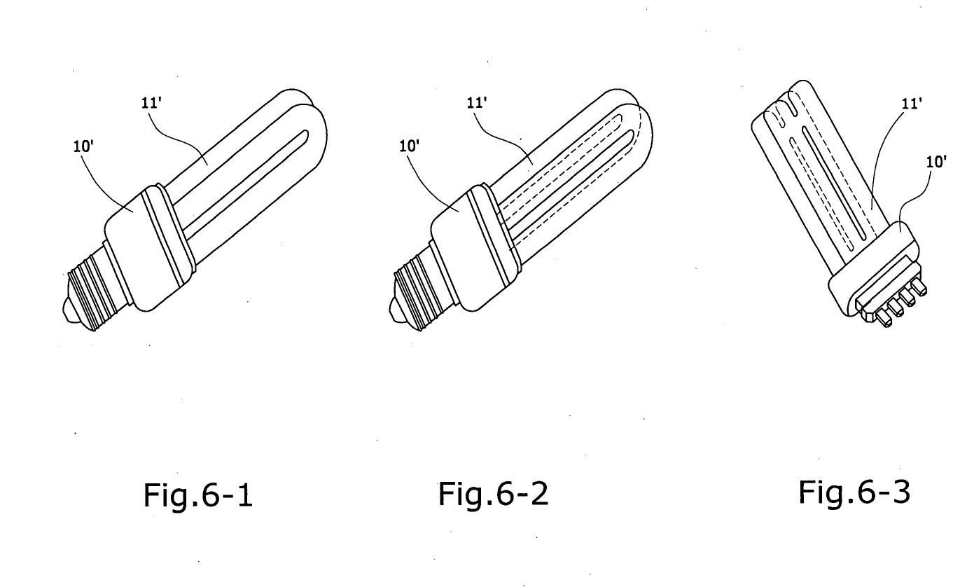

The lamp of the ultraviolet lamp of the invention may be of sleeve types per FIGS. 1 to 3, or other shapes per FIGS. 4 to 6. The sleeve-type lamp may have no electrode, the said indicator is installed on any end near the sleeve-type lamp. The ultraviolet lamp may be of the non-electrode type, which means one or several ultraviolet-emission lamps have to be vacuum-sealed with a certain quantity of mercury.

The ultraviolet of the ultraviolet lamp of the invention may be produced while the microwaves ionize the mercury or its substitute that is embedded in the lamp sleeve.

The indicator of the ultraviolet lamp of the invention comprises the substance that is able to transfer ultraviolet energy into colored visible light.

In order to strengthen the observation effects, a substance, which is able to strengthen the light or adjust the spectrum, is painted or installed between the indicator 20, 20′, 20″ and the lamp 11, 11′, 11″.

In order to directly observe the strength of the ultraviolet, the color match 30, 30′, 30″ (as shown per FIGS. 1 to 3) of color shades is installed on the outer surface or inner surface of the lamp 11, 11′, 11″ and by the side of indicator 20, 20′, 20″. The strength of the ultraviolet can be directly observed through comparing visible light to the said color match 30, 30′, 30″.

New characteristics and advantages of the invention covered by this document have been set forth in the foregoing description. Understanding is sought however, that the drawings are for the purpose of illustration only and not intended to be a definition of the limits of the invention. Changes in methods, shapes, structures, or devices may be made in detail without exceeding the scope of the invention by those who are skilled in the art. The scope of the invention is, of course, defined in the language in which the appended claims are expressed.

To sum up, the “ultraviolet lamp” of the invention substantively elevates the usage efficiency and convenience of the grinder so as to possess the “practicability” and the “advancement” in the industry field. Furthermore, the structure of the invention has not been released by any publication or used in public prior to this patent application. Therefore, the structure of the invention meets the new utility model requirements and is submitted for the patent application according to the Patent Act.

What is claimed is:

1. An “ultraviolet lamp” that comprises of a lamp that transmits ultraviolet light; the characteristic lies in: there is a substance inside the said lamp that is able to produce ultraviolet light by electrode or microwave and there is one or several indicators on said lamp that are able to transfer the ultraviolet into visible light.

2. The characteristic of the “ultraviolet lamp” of claim 1 lies in: the said lamp is of a sleeve type and the said indicator is installed on the wall adjoining one or several ends of the sleeve-type lamp.

3. The characteristic of the “ultraviolet lamp” of claim 1 lies in: the ultraviolet lamp comprises of one or several of the said lamps and several lamps are horizontally in parallel connection; the said indicator is installed on the wall adjoining one or several ends of the said lamp.

4. The “ultraviolet lamp” of claim 1, the characteristic lies in: the said lamp is of a sleeve type and bent into one or several arc-shaped tubes; the said indicator is installed on the wall adjoining one or several ends of said lamp.

5. The characteristic of the “ultraviolet lamp” of claim 2 lies in: the said indicator, which comprises the substance that is able to transfer ultraviolet energy into visible light.

6. The characteristic of the “ultraviolet lamp” of claim 5, lies in: the said indicator, which comprises the substance that can transfer ultraviolet energy into colored visible light.

7. The characteristic of the “ultraviolet lamp” of claim 2 lies in: the substance, which is able to strengthen the light or adjust the spectrum, is installed between the said indicator and the said lamp.

8. The characteristic of the “ultraviolet lamp” of claim 2 lies in: the said substance, which can transfer the ultraviolet energy into colored visible light, is phosphorus or fluorescent powder.

9. The characteristic of the “ultraviolet lamp” of claim 2 lies in: the color match is installed beside the said indicator that is installed on the wall of the said lamp.

10. The characteristic of the “ultraviolet lamp” of claim 2 lies in: a transparent or opaque character or sign is installed on top of the said indicator that is installed on the wall of the said lamp.

11. The characteristic of the “ultraviolet lamp” of claim 3 lies in: the said indicator, which comprises the substance that is able to transfer ultraviolet energy into visible light.

12. The characteristic of the “ultraviolet lamp” of claim 4 lies in: the said indicator, which comprises the substance that is able to transfer ultraviolet energy into visible light.

13. The characteristic of the “ultraviolet lamp” of claim 11, lies in: the said indicator, which comprises the substance that can transfer ultraviolet energy into colored visible light.

14. The characteristic of the “ultraviolet lamp” of claim 12, lies in: the said indicator, which comprises the substance that can transfer ultraviolet energy into colored visible light.

15. The characteristic of the “ultraviolet lamp” of claim 3 lies in: the substance, which is able to strengthen the light or adjust the spectrum, is installed between the said indicator and the said lamp.

16. The characteristic of the “ultraviolet lamp” of claim 4 lies in: the substance, which is able to strengthen the light or adjust the spectrum, is installed between the said indicator and the said lamp.

17. The characteristic of the “ultraviolet lamp” of claim 3 lies in: the said substance, which can transfer the ultraviolet energy into colored visible light, is phosphorus or fluorescent powder.

18. The characteristic of the “ultraviolet lamp” of claim 4 lies in: the said substance, which can transfer the ultraviolet energy into colored visible light, is phosphorus or fluorescent powder.

19. The characteristic of the “ultraviolet lamp” of claim 3 lies in: the color match is installed beside the said indicator that is installed on the wall of the said lamp.

20. The characteristic of the “ultraviolet lamp” of claim 4 lies in: the color match is installed beside the said indicator that is installed on the wall of the said lamp.

21. The characteristic of the “ultraviolet lamp” of claim 3 lies in: a transparent or opaque character or sign is installed on top of the said indicator that is installed on the wall of the said lamp.

22. The characteristic of the “ultraviolet lamp” of claim 4 lies in: a transparent or opaque character or sign is installed on top of the said indicator that is installed on the wall of the said lamp.
